(19) United States
(12) Patent Application Publication
(10) Pub. No.: US 2025/0007052 A1
(43) Pub. Date: Jan. 2, 2025

(54) Battery Cell and Battery Module Comprising the Same

(71) Applicant: LG Energy Solution, Ltd., Seoul (KR)

(72) Inventors: Jong Yoon Keum, Daejeon (KR); Bum Choi, Daejeon (KR); Hee Gyu Kim, Daejeon (KR); Jae Heon Chung, Daejeon (KR)

(73) Assignee: LG Energy Solution, Ltd., Seoul (KR)

(21) Appl. No.: 18/697,780

(22) PCT Filed: Mar. 29, 2023
(86) PCT No.: PCT/KR2023/004148

§ 371 Date: Apr. 2, 2024

(30) Foreign Application Priority Data
Mar. 29, 2022 (KR) 10-2022-0038474

(51) Int. Cl. H01M 50/145; H01M 10/613; H01M 10/6567; H01M 50/119; H01M 50/121; H01M 50/124; H01M 50/141; H01M 50/24

(52) U.S. Cl. CPC H01M 50/145; H01M 10/613; H01M 10/6567; H01M 50/119; H01M 50/121; H01M 50/1245; H01M 50/141; H01M 50/24

(57) ABSTRACT

A battery cell and a battery module include a direct water-cooling battery cell and a direct water-cooling battery module. The corrosion resistance of the battery cell can be improved by using a sacrificial metal having a higher metal ionization tendency than that of a battery cell case, and the battery cell can be cooled by using general cooling water for vehicles.

### CROSS-REFERENCE TO RELATED APPLICATIONS

The present application is a national phase entry under 35 U.S.C. § 371 of International Application No. PCT/KR2023/004148 filed Mar. 29, 2023, which claims the benefit of Korean Patent Application No. 10-2022-0038474 filed on Mar. 29, 2022, with the Korean Intellectual Property Office, the entire contents of which are incorporated herein by reference.

### BACKGROUND OF THE INVENTION

### Technical Field

The present disclosure relates to a battery cell and a battery module comprising the same. Particularly, the disclosure relates to a direct water-cooling battery cell and a direct water-cooling battery module comprising the same, and more specifically, to a direct water-cooling battery cell capable of improving corrosion resistance of the battery cell by using a sacrificial metal having a higher metal ionization tendency than that of a battery cell case, and a direct water-cooling battery module comprising the same.

### Background Art

Batteries used in eco-friendly vehicles generate a large amount of heat because high power is required, and in order to improve battery performance and lifespan, it is very important to efficiently discharge heat generated from the battery, thereby preventing the batteries from overheating.

Conventionally, as a cooling system for dissipating heat from a battery, a direct air-cooling method, an indirect water-cooling method, or a direct water-cooling method is known.

The direct water-cooling method is a method in which battery cells are directly immersed in cooling water, and heat from the battery cells is directly discharged into the cooling water.

FIG. 1 is a schematic configuration diagram of a conventional battery module (10).

Referring to FIG. 1, a direct water-cooling type battery module (10) consists of a cell frame (11) and a plurality of battery cells (12). The plurality of battery cells (12) are spaced apart from each other in the cell frame (11). The cell frame (11) is provided so that cooling water can flow.

Generally, in the battery cell (12), an exterior case accommodating internal electrodes is made of nickel-plated iron. Accordingly, when the battery cell (12) is directly impregnated with cooling water, it is vulnerable to corrosion due to the material characteristics of the exterior case. In addition, there is a problem that the exterior case is polar and also has vulnerable electrical insulation.

In order to prevent corrosion of the battery cell (12) in the battery module (10) of the conventional direct water-cooling method, insulating oil or special cooling water (M) (e.g., 3M's NOVEC) is used.

However, the insulating oil has a problem of being vulnerable to fire, and the special cooling water such as 3M's NOVEC is excellent as a coolant for battery cells in that it is non-polar and has corrosion resistance, but it is expensive, whereby there is a problem of increasing the manufacturing cost of the battery module.

Also, when an antirust liquid is applied to the exterior case of the battery cell (12) in order to prevent corrosion of the battery cell (12) as in the conventional art, a post-treatment process of covering the exterior case of the battery cell (12) using a non-woven fabric is required to maintain the antirust liquid.

In addition, even if the antirust liquid is applied to the exterior case of the battery cell (12), the antirust agent flows down from the exterior case of the battery cell due to surface tension, whereby there is a problem that the antirust agent is not evenly applied to the exterior case.

### BRIEF SUMMARY OF THE INVENTION

### Technical Problem

The present disclosure provides a direct water-cooling battery cell capable of improving corrosion resistance of a battery cell by using a sacrificial metal having a higher metal ionization tendency than that of a battery cell case, and a direct water-cooling battery module comprising the same.

### Technical Solution

A battery cell for direct water cooling according to one example of the present invention comprises an electrode assembly, a case accommodating the electrode assembly, a first plating layer formed on an outer surface of the case, and a sacrificial metal part provided to surround the first plating layer and formed of a material having a higher metal ionization tendency than that of the first plating layer.

The sacrificial metal part may comprise one or more selected from the group consisting of aluminum, magnesium, zinc, an aluminum alloy, a magnesium alloy, and a zinc alloy.

Also, the first plating layer may comprise a nickel-plating layer.

In addition, the battery cell may comprise a waterproof sheet including a polymer film and provided to surround the sacrificial metal part

Furthermore, the waterproof sheet may surround the outer surface of the case so that one end of the waterproof sheet and the other end of the waterproof sheet overlap along the circumferential direction of the case.

Also, the waterproof sheet may be in close contact with the sacrificial metal part while being subjected to heat-shrinkage.

In addition, the sacrificial metal part may be welded on the first plating layer.

Furthermore, the sacrificial metal part may be laser-welded to the first plating layer.

Also, the sacrificial metal part may be provided to surround a partial region of the case in a band shape.

In addition, the sacrificial metal part may be provided to surround the case along the circumferential direction of the case in a ring shape.

Furthermore, the battery cell may comprise a cell sheet disposed between the sacrificial metal part and the waterproof sheet, and containing an antirust agent.

Also, the battery module for direct water cooling according to another aspect of the present invention comprises the plurality of battery cells, a cell frame provided so that the plurality of battery cells is disposed apart from each other, and cooling water allows to flow between the plurality of battery cells, and a cooling water supply part for supplying cooling water into the cell frame.

In addition, the battery module may comprise a waterproof layer provided inside the cell frame and provided to cover the side end of the upper surface and the side end of the lower surface of the case, respectively.

Furthermore, the waterproof layer may comprise a waterproof adhesive or a potting resin.

In addition, the cooling water supply part may be provided to supply cooling water that is not insulated.

### Advantageous Effects

The direct water-cooling battery cell related to at least one example of the present disclosure, and the direct water-cooling battery module comprising the same have the following effects.

The corrosion resistance of the battery cell can be improved by using a sacrificial metal having a higher metal ionization tendency than that of the case of the battery cell. In addition, the battery cell can be cooled by using a low-cost, non-insulated general cooling water for vehicles.

In addition, heat resistance, waterproof capabilities, and insulation properties of the battery cell may be improved through the waterproof sheet surrounding the sacrificial metal part.

### DESCRIPTION OF DRAWINGS

FIG. 1 is a side view of a conventional battery module according to the prior art.

FIG. 2 is a side view showing reactivity of moisture in a direct water-cooling battery module cooling according to an example of the present disclosure when the battery module is immersed in cooling water for a long time.

FIG. 3 is a perspective view of a battery cell according to an example of the present invention.

FIG. 4 is a side cross-sectional view of a battery cell according to an example of the present invention.

FIGS. 5 and 6 are side cross-sectional views of a battery cell according to an example of the present invention.

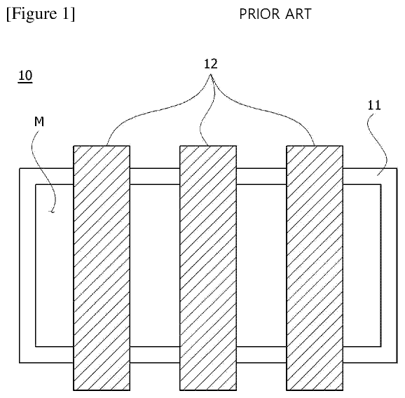

### DETAILED DESCRIPTION OF THE PREFERRED EMBODIMENTS

Hereinafter, a direct water-cooling battery cell according to one example of the present invention (hereinafter, also referred to as a ‘battery cell’), and a direct water-cooling battery module comprising the same (hereinafter, also referred to as a ‘battery module’) will be described in detail with reference to the drawings.

In addition, regardless of the reference numerals, the same or corresponding components are denoted by the same or similar reference numerals, duplicate descriptions thereof will be omitted, and for convenience of explanation, the size and shape of each component member as shown can be exaggerated or reduced.

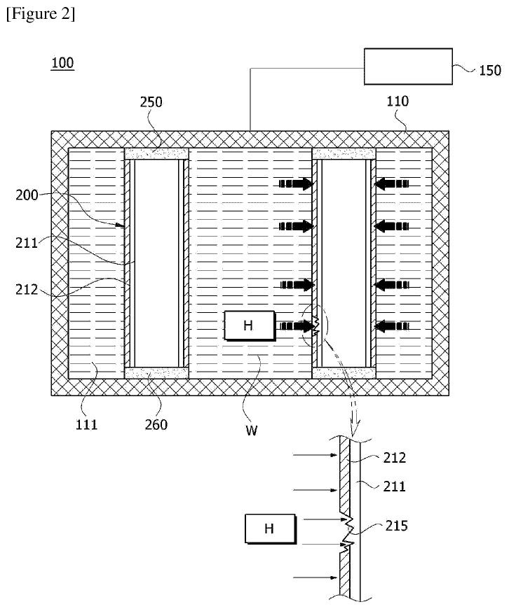

FIG. 2 is a diagram for explaining reactivity of moisture in a direct water-cooling battery module cooling according to one example of the present invention when immersed in cooling water for a long time.

As shown in FIG. 2, the battery module (100) according to this example comprises a plurality of battery cells (200), a cell frame (110) and a cooling water supply part (150). In addition, the battery module (100) comprises a plurality of battery cells (200), a cell frame (110) provided so that the plurality of battery cells (200) is disposed apart from each other, and cooling water (W) allows to flow between the plurality of battery cells (200), and a cooling water supply part (150) for supplying cooling water into the cell frame (110).

The cell frame (110) has a predetermined space part (111) therein, and is provided in a structure in which cooling water (W) can flow within the space part (111). The cooling water (W) may be supplied to the inner space part (111) of the cell frame (110), and then discharged to the outside of the cell frame (110), and to this end, the battery module (100) may comprise a cooling water discharge part for discharging the cooling water (W) to the outside of the cell frame (110). The cooling water supply part (150) may comprise a cooling water storage tank and a pump. In addition, the cooling water supply part (150) may be provided to supply cooling water (W) that is not insulated. The general cooling water (W) may be cooling water generally used in vehicles.

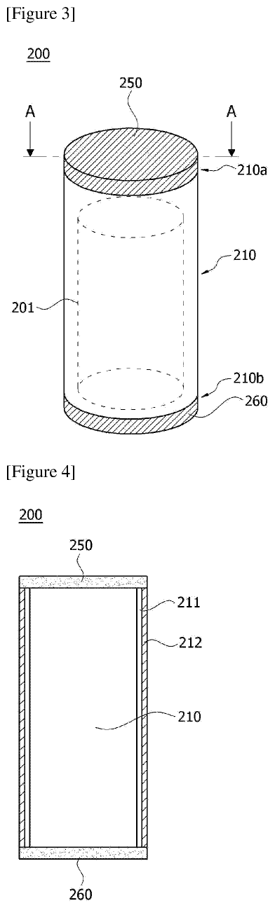

FIG. 3 is a perspective diagram schematically showing a battery cell (200) according to one example of the present invention, and FIG. 4 schematically illustrates a cross section of a battery cell according to one example of the present invention, which is taken from section A-A of FIG. 3.

A battery cell (200) according to one example of the present invention comprises an electrode assembly (201), a case (210) accommodating the electrode assembly (201), a first plating layer (211) formed on an outer surface of the case (210), and a sacrificial metal part (212) provided to surround the first plating layer (211) and formed of a material having a higher metal ionization tendency than that of the first plating layer (211).

Referring to FIG. 2, when the direct water-cooling battery cell (200) is immersed in cooling water (W), the moisture (H) may be transferred to the sacrificial metal part (212). The sacrificial metal part (212) is provided so that, the metal ionization reaction to moisture is greater than the metal ionization reaction to moisture of the case (210). Accordingly, corrosion resistance of the case (210) may be improved.

As one example, the sacrificial metal part (212) may be plated on the first plating layer (211), and may also be welded on the first plating layer (211).

Referring to FIG. 2, when the battery module (100) uses general cooling water (W), the moisture (H) penetrates through the corroded portion on the surface of the battery cell (200), and then the power source of the battery cell (200) is energized with the general cooling water, which may potentially damage the battery module (100).

For example, even when scratches (215) are present on the surface of the battery cell (200), the ionization tendency of the sacrificial metal is greater than that of the first plating layer (211) or the case (210), and thus the moisture (H) reacts the sacrificial metal.

Referring to FIG. 2, when the direct water-cooling battery cell (200) is immersed in the cooling water (W), due to the metal ionization reaction difference between the case (210) and the sacrificial metal part (212) in the direct water-cooling battery cell (200), the moisture (H) of the cooling water (W) is subjected to an ionization reaction with the sacrificial metal part (212), and as a result, the metal ionization reaction of the case (210) is suppressed, whereby it is possible to prevent corrosion of the case (210).

Referring to FIG. 3, the electrode assembly (201) is accommodated in the case (210), and comprises a positive electrode, a negative electrode, and a separator disposed between the positive electrode and the negative electrode. The electrode and the separator may constitute an integrated electrode assembly (201). For example, the electrode assembly (201) may be a jelly-roll type electrode assembly in which sheet-type positive and negative electrodes are wound in a state where a separator is interposed therebetween, a stack type electrode assembly in which pluralities of positive and negative electrodes are sequentially stacked in a state where a separator is interposed therebetween, or a stack/folding type electrode assembly in which unit cells obtained by stacking positive and negative electrodes in predetermined units in a state where a separator is interposed therebetween are sequentially wound in a state where they are positioned on a separation film.

The case (210) additionally serves to accommodate the electrode assembly (201), and to protect the battery cell (120) from external impacts. The case (210) may be cylindrical, pouch, or angular. In particular, the electrode assembly may be a rolled jelly-roll type electrode assembly configured to be housed within a cylindrical case, and the direct water-cooling battery cell (200) may be a cylindrical battery cell.

In addition, the case (210) may be formed of a metal material, and the case (210) may be formed of one or more selected from the group consisting of steel or stainless steel.

The surface of the case (210) may be treated with nickel (Ni) plating. That is, the first plating layer (211) may comprise a nickel-plating layer.

The sacrificial metal part (212) may be formed of a material having a higher metal ionization reaction than that of the case (210). The sacrificial metal part (212) may comprise one or more selected from the group consisting of aluminum, magnesium, zinc, an aluminum alloy, a magnesium alloy, and a zinc alloy.

Referring to FIGS. 2 and 4, the sacrificial metal part (212) may be provided on an outer surface of the case (210). The sacrificial metal part (212) may be provided on the upper end (210a) and the lower end (210b) of the case (210), respectively. Alternatively, the sacrificial metal part (212) may be provided in the central region between the upper end and the lower end of the case (210). In addition, the sacrificial metal part (212) may also be plated over the entire region on the first plating layer (211). The sacrificial metal part (212) may be provided to surround a partial region of the case (210) in a band shape. The sacrificial metal part (212) may surround the case along the circumferential direction of the case (210) in a ring shape. In addition, the sacrificial metal part (212) may be welded on the first plating layer (211), and the sacrificial metal part (212) may be laser-welded to the first plating layer (211).

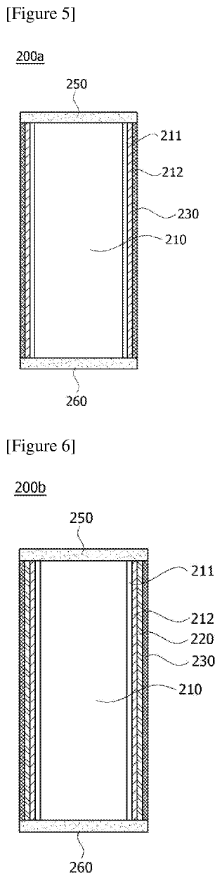

FIGS. 5 and 6 schematically illustrate cross-sections of battery cells (200a, 200b) according to another example of the present invention.

Referring to FIG. 5, the battery cell (200a) may comprise a waterproof sheet (230) including a polymer film configured to surround the sacrificial metal part (212).

The waterproof sheet (230) may surround the outer surface of the case (210) such that one end of the waterproof sheet (230) and the other end of the waterproof sheet (230) overlap along the circumferential direction of the case (210). In addition, the waterproof sheet (230) may be in close contact with the sacrificial metal part (212) while being subjected to heat-shrinkage.

The waterproof sheet (230) may be formed of a heat-shrinkable polymer material. The heat-shrinkable polymer material may comprise one or more selected from the group consisting of polyvinyl chloride (PVC), polypropylene (PP), and polyethylene terephthalate (PET).

Referring to FIG. 6, the battery cell (200b) may comprise a cell sheet (220) disposed between the sacrificial metal part (212) and the waterproof sheet (230), and may an antirust agent.

The cell sheet (220) may comprise a corrosion-resistant material, where the corrosion-resistant material may be an antirust agent in which a substance such as a phosphate, a silicate, an organic acid salt, or a rubber grease is included.

In general, when only the antirust agent is applied to the case (210), the antirust agent flows down from the case (210) due to surface tension. On the contrary, in the present invention, the cell sheet (230) is attached to the case (210) through an adhesive or the like to surround the sacrificial metal part (212), so that it is possible to prevent a corrosion-resistant material (e.g., antirust agent) from flowing down.

The cell sheet (220) may be formed of a material capable of evenly absorbing a corrosion-resistant material, and may be formed of, for example, fabrics such as non-woven fabrics or cotton fabrics. In addition, the cell sheet (220) may be bonded to the sacrificial metal part (212), as a sheet adhesive applied in a high temperature-melted state by a hot melting method and then cooled. Here, an acrylic adhesive may be used as the sheet adhesive.

The cell sheet (220) may be provided such that one end of the cell sheet (220) overlaps the other end of the cell sheet (220). At this instance, the overlapped region has a step difference, where the stepped region of the cell sheet (220) may be sealed with a sealing material. The sealing material may be a material containing a resin, a plasticizer, an antioxidant, and a wax.

Thereafter, the waterproof sheet (230) surrounds the cell sheet (220) and is tightly coupled to the outer surface of the case (210) while being subjected to heat-shrinkage.

The battery module (100) may comprise a waterproof layer (250, 260) provided inside the cell frame (110), and provided to cover the upper end (210a) and the lower end (210b) of the case (210) of the battery cell (200), respectively.

The waterproof layer (250, 260) prevents moisture from permeating into the case (210), and performs a function of fixing the battery cell (200) to the cell frame (110).

An upper waterproof layer (250) may be provided on the upper end of the case (210), and a lower waterproof layer (260) may be provided on the lower end of the case (210). As one example, the waterproof layers (250, 260) may be provided to surround a partial region of the sacrificial metal part (212). In this structure, the sacrificial metal part (212) does not contact the cooling water (W) inside the cell frame (110) by the waterproof layers (250, 260). In addition, the upper end (210a) side and the lower end (210b) side of the battery cell (200) may be fixed to the inner surface of the cell frame (110) through waterproof layers (250, 260), respectively.

The waterproof layer (250, 260) may comprise a waterproof adhesive or a potting resin, and the potting resin may be any one of a silicone-based resin, a urethane-based resin, and an epoxy-based resin.

The preferred examples of the present disclosure are described above have been disclosed for illustrative purposes, and those skilled in the art having ordinary knowledge of the present disclosure will be able to make various modifications, changes, and additions within the spirit and scope of the present disclosure, and such modifications, changes, and additions should be regarded as falling within the scope of the following claims.

### INDUSTRIAL APPLICABILITY

According to the direct water-cooling battery cell related to at least one example of the present disclosure, and the direct water-cooling battery module comprising the same, the corrosion resistance of the battery cell can be improved by using a sacrificial metal having a higher metal ionization tendency than that of the case of the battery cell.

1. A battery cell comprising:
an electrode assembly;
a case configured to house the electrode assembly;
a first plating layer formed on an outer surface of the case; and
a sacrificial metal part surrounding the first plating layer and formed of a material having a higher metal ionization tendency than that of the first plating layer.

2. The battery cell according to claim 1, wherein
the sacrificial metal part comprises one or more selected from the group consisting of aluminum, magnesium, zinc, an aluminum alloy, a magnesium alloy, and a zinc alloy.

3. The battery cell according to claim 1, wherein
the first plating layer comprises a nickel-plating layer.

4. The battery cell according to claim 1, further comprising
a waterproof sheet including a polymer film surrounding the sacrificial metal part.

5. The battery cell according to claim 4, wherein
the waterproof sheet is configured to surround the outer surface of the case so that a first end of the waterproof sheet and an opposing second end of the waterproof sheet overlap along the circumferential direction of the case.

6. The battery cell according to claim 4, wherein
the waterproof sheet contacts the sacrificial metal part.

7. The battery cell according to claim 1, wherein
the sacrificial metal part is welded on the first plating layer.

8. The battery cell according to claim 7, wherein
the sacrificial metal part is laser-welded to the first plating layer.

9. The battery cell according to claim 1, wherein
the sacrificial metal part is configured to surrounds a partial region of the case in a band shape.

10. The battery cell according to claim 1, wherein
the sacrificial metal part is configured to surrounds the case along the circumferential direction of the case in a ring shape.

11. The battery cell according to claim 4, further comprising
a cell sheet disposed between the sacrificial metal part and the waterproof sheet, the cell sheet including an antirust agent.

12. A battery module comprising:
a plurality of battery cells according to claim 1;
a cell frame configured to house the plurality of battery cells such that individual battery cells of the plurality of battery cells are spaced apart from each other such that cooling water is configured to flow between the plurality of battery cells; and
a cooling water supply part configured to supply cooling water into the cell frame.

13. The battery module according to claim 12, wherein
the battery module includes a waterproof layer inside the cell frame and configured to cover a side end of an upper surface and a side end of a lower surface of the case, respectively, wherein
the waterproof layer further includes a waterproof adhesive or a potting resin.

14. The battery module according to claim 12, wherein
the cooling water supply part is configured to supply non-insulated cooling water.
